(19) United States
(12) Patent Application Publication
(10) Pub. No.: US 2008/0250325 A1
(43) Pub. Date: Oct. 9, 2008

(54) Integrated Development Environment with Object-Oriented GUI Rendering Feature

(76) Inventors: Barry A. Feigenbaum, Austin, TX (US); Michael A. Squillace, Austin, TX (US)

Correspondence Address: IBM CORP. (MRN);c/o LAW OFFICE OF MICHAEL R. NICHOLS, 5100 Eldorado Pkwy. Ste. 102, PMB 523, MCKINNEY, TX, 75070, US

(21) Appl. No.: 11/695,658

(22) Filed: Apr. 3, 2007

(51) Int. Cl. G06F 3/00

(52) U.S. Cl. 715/744

(57) ABSTRACT

A method, computer program product, and data processing system for supporting an integrated development environment (IDE) for efficient graphical user interface (GUI) programming in source code are provided. The IDE user selects one or more GUI components for immediate rendering. The IDE, which has its own GUI, contains an event handler that detects modifications to the source code to the selected components. When a modification is detected, the IDE attempts to compile the source code to the modified component. If the compilation succeeds, the IDE dynamically loads the newly compiled code and executes the newly compiled code to render the component in the IDE's own runtime environment. Subsequent modifications to the component's source code result in immediate recompilation and rerendering of the component by the IDE so that the user is provided instant feedback as the GUI source code is modified.

### BACKGROUND OF THE INVENTION

1. Technical Field

The present invention relates generally to tools for programming graphical user interfaces in computer software applications. More specifically, the present invention provides an integrated development environment that is capable of rendering graphical user interfaces that have been defined using object-oriented program code.

2. Description of the Related Art

The earliest interactive computers relied on tele-typewriter (TTY) or text terminals for interactive communication with a human operator. These early forms of human-computer interaction (HCI) allowed for only text- or character-based information exchange. Many computer software products today utilize a graphical user interface or GUI (typically pronounced like “gooey”). A GUI is visual means of human-computer interaction that utilizes pictures or other visual representations besides text or characters.

Most GUIs make use of visual controls that are displayed on the user's display and actuated by user input. Typical visual controls include, but are not limited to, buttons, text fields (for entering text), radio buttons, checkboxes, selection boxes, and menu bars. In a typical GUI, a pointing device, such as a mouse, is used to move a cursor around a display and actuate visual controls. GUIs usually also make use of static display components, such as labels and icons, which are intended to be displayed, but generally have no input function, per se. Sometimes these static display components may serve an input role, however, when they are moved around on the display relative to other features on the display (e.g., dragging an icon of a file to a trash can icon to delete a file, for example).

Many GUIs are what is known as a “windowing” interface, because they arrange information visually on a display in the form of panels or “windows” superimposed on a background called a “desktop.” In many systems, windows may be dragged to different locations on the display with a pointing device, enlarged, reduced, made to overlap with other windows. Typically, a window will contain a number of visual controls to allow a user to interact with a computer program by actuating the controls in the window. A special form of window, known as a “dialog box,” is displayed by a program when some input is required from a user.

Windows, visual controls, and static display components are what are known as GUI components, because they are the building blocks that make up the GUI. Some GUI components, such as windows, are known as “container components” (or simply “containers”), because they may contain other components. For example, a window may contain visual controls, such as a button or menu bar, and static display components, such as text labels or icons. A container may also contain another container. For example, in some windowing-based word processors, the word processor itself occupies a (main) window, while each file under editing occupies another window within the main window.

Container components include windows, but may also include other components, which may be visible or invisible. For example, the JAVA™ programming language produced by Sun Microsystems, Inc. of Mountain View, Calif., defines various visible container components, such as windows and dialog boxes, as well as invisible container components, such as the “java.awt.Panel” container component, which is used solely to group a number of contained components into a single unit. Some examples of containers include, but are not limited to, windows, dialog boxes, panels, tabbed panels, notebook pages, and any other GUI components that have a capability of containing one or more other GUI components.

The actual functionality for providing basic operations on GUI components, such as displaying the components or detecting user input directed at the components (e.g., from pointing at or clicking on a component with a pointing device), is often provided by system-level software, such as an operating system. Generally speaking, applications will issue calls to system-level software for creating and maintaining GUIs, while the system-level software detects user input events that are directed at particular GUI components and sends event notifications to the applications that are responsible for those GUI components.

For example, the WINDOWS® operating system produced by Microsoft, Inc. of Redmond, Wash. provides services for the creation of GUIs and relaying of user input events to appropriate applications. The main interface for the WINDOWS® operating system itself is a GUI as well. In other settings, higher-level system software may operate on top of an operating system kernel (e.g., as a daemon or background process) to provide GUI services. For example, “X11” is an open-source GUI engine that operates as a process in an operating system. X11 adopts a client-server model in that an X11 server process accepts requests from applications (clients) for providing GUI services and relays user input events that pertain to particular GUI components to the applications associated with those components.

Alternatively, an application may contain its own code for providing GUI services. Typically, this code will come in the form of a reusable code library for performing basic GUI operations.

Many modern programming language implementations have built-in features for producing GUIs, usually either by providing an interface to GUI services provided by system-level software or by including libraries of low-level GUI code for which an interface in the programming language is provided. The JAVA™ programming language, for example, is an object-oriented programming language that includes standard application programming interfaces (APIs) for defining GUIs. Two APIs that are currently part of the JAVA™ programming language standard are the Abstract Windowing Toolkit (AWT) API and the Swing API. In the JAVA™ programming language, as is typical of object-oriented GUI APIs, each type of GUI component is defined as a class.

In an object-oriented programming language, a class is a definition of a data type that includes a collection of data, called member variables, and a set of operations that may be performed on the data, called methods (or alternatively, member functions). An actual collection of data in the data type defined by a class is called an object. In object-oriented programming (OOP) parlance, an object is said to be an “instance” of the class, because it is a data structure that is defined in accordance with the class. The run-time process of generating an object in an object-oriented programming language is called “instantiation,” and an object that exists at run-time is said to be “instantiated.”

Object-oriented programming languages also typically provide for what is known as “inheritance.” Using an inheritance a new class (called a “descendant” class) can be defined in terms of one or more existing classes (called “base” classes) so that the descendant class inherits one or more of the member variables or methods of the base class. For example, in the JAVA™ programming language's AWT API, “Container” is a descendant class of a base class called “Component,” the “Container” class will include at least some of the methods and member variables of “Container.” We thus say that “Container” is descended from “Component.” In many cases, a descendant class will include additional methods or member variables that are not inherited from the base class.

Also, a descendent class may be written so as to override the base class's code for a particular method. For example, the base class “Container” may have a method called “show,” for displaying a GUI component, which the descendant class “Container” inherits. Since displaying a container (which may contain other components) is more specific than displaying a generic GUI component, the “Container” class may define different code for “show” than that of the “Component” class.

This is important, since in most object-oriented languages, an object in a descendant class is treated as being a more specific instance of the base class. Thus, a “Container” object may be stored in a variable of type “Component,” or a method that takes a “Component” as an argument can also take a “Container” as an argument, since a “Container” will inherit characteristics (i.e., member variables and methods) from “Component.” This ability to treat objects from descendant classes as if they were instances of base classes is called “polymorphism.”

In an object-oriented GUI API, such as those provided by the JAVA™ programming language, GUI components are instantiated as objects, and relationships are established between the instantiated objects in order to define the placement and behavior of GUI components with respect to each other. For example, a “containment relation” is a relationship between GUI components that relates a container component to the components contained by that container component. In the JAVA™ programming language, for example, a component typically enters into a containment relation with a container through a method of the container called “add.”

A typical GUI component has one or more attributes that define particular properties of the component. For example, a “button” component in a typical windowing GUI will have attributes that define the size of the button on the display, the text or graphics displayed on the face of the button, the background color of the button, a keyboard shortcut associated with the button, and the like. In general, the portion of program code (e.g., function, method, subroutine, procedure, etc.) that instantiates a GUI component will also contain a number of lines of code that set the attributes for that component to desired values. In the JAVA™ programming language and other object-oriented programming systems, for example, components generally have methods that can be executed to set particular attributes of the component.

While using an object-oriented programming language to define a GUI can afford the programmer much flexibility in design and implementation, one commonly-encountered inconvenience of programming a GUI directly in a programming language (over a visual GUI editor, for example) is that the programmer must generally recompile and execute the under-development program to view the impact of any changes made to the GUI, however minor those changes might be. For example, when programming a GUI in (text-based) source code most sizes and distances must be specified in terms of a number of horizontal and vertical pixels. It can be very difficult to estimate these sizes and distances accurately when programming source code, particular when aspect ratios (which usually cause there to be more pixels horizontally than vertically on a screen) are taken into account. Many compile-run-modify iterations may be needed to achieve a functional and aesthetically-pleasing GUI layout/design. This can become very tedious.

What is needed, therefore, is a development environment that reduces the need for the compile-run-modify iterative approach to GUI development in source code. The present invention provides a solution to this and other problems, and offers other advantages over previous solutions.

### SUMMARY OF THE INVENTION

Accordingly, the present invention provides a method, computer program product, and data processing system for supporting an integrated development environment (IDE) for efficient graphical user interface (GUI) programming in source code. The IDE user selects one or more GUI components for immediate rendering. The IDE, which has its own GUI, contains an event handler that detects modifications to the source code to the selected components. When a modification is detected, the IDE attempts to compile the source code to the modified component. If the compilation succeeds, the IDE dynamically loads the newly compiled code and executes the newly compiled code to render the component in the IDE's own runtime environment. Subsequent modifications to the component's source code result in immediate recompilation and rerendering of the component by the IDE so that the user is provided instant feedback as the GUI source code is modified.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram of a graphical user interface rendered inside of an integrated development environment in accordance with a preferred embodiment of the present invention;

FIG. 2 is a flowchart representation of a event handler in an integrated development environment made in accordance with a preferred embodiment of the present invention; and

FIG. 3 is a block diagram of a data processing system in which a preferred embodiment of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

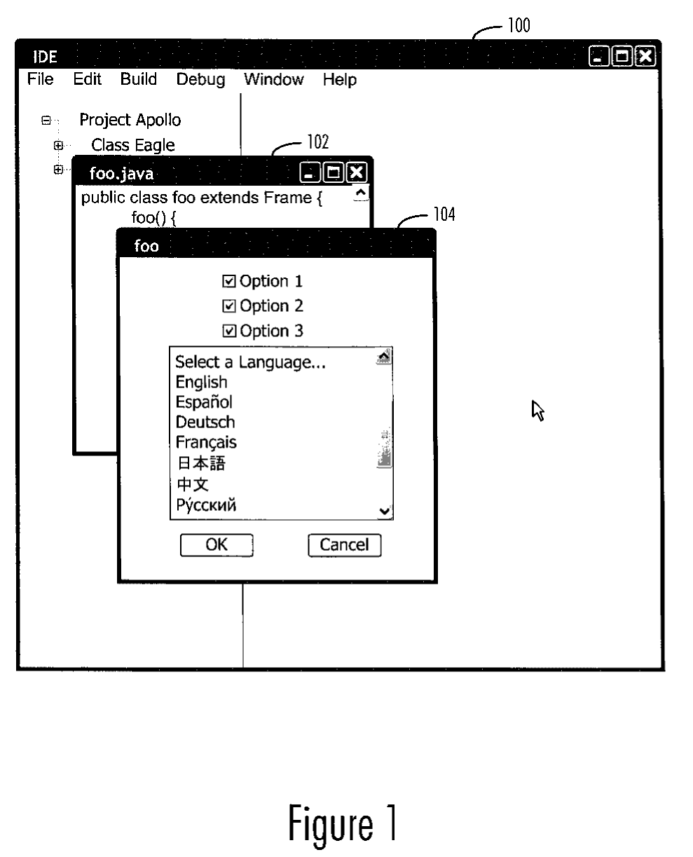

FIG. 1 is a diagram illustrating the graphical user interface (GUI) of an integrated development environment (IDE) in accordance with a preferred embodiment of the present invention. An IDE is a unified program development tool that provides both source code editing and program build (compilation and linking) features. Many IDEs also provide some kind of integrated debugging feature (such as a step/trace debugger) as well. One example of an IDE in which the present invention may be implemented is Eclipse, which is actually an open-source extensible framework for constructing custom IDEs for various languages. Eclipse itself is implemented in the JAVA programming language and available from the World-Wide Web at http://www.eclipse.org.

The IDE depicted in FIG. 1 includes a main window 100, providing pull-down menu access to the main features of the IDE. Within main window 100 is a text editor window 102 for editing source code files. In this example, text editor window 102 is being used to edit JAVA source code for providing a dialog box.

Because of naming conventions required by JAVA, every public class must be contained in a separate source code file having the same name (minus the “.java” file extension) as the public class. Since GUI components in JAVA (or in the Eclipse toolkit, for that matter) are defined as classes, each GUI component defined in a given program will have a JAVA source file associated with it. Further, since GUI components are generally defined as descendants of some base class in a GUI toolkit, it is relatively simple to determine if a given JAVA source code file defines a renderable GUI component. For example, all GUI components defined using JAVA's Abstract Windowing Toolkit (AWT) are descended (directly or transitively) from the class java.awt.Component. Thus, if a given source file defines a class that is descended from java.awt.Component, the class is a GUI component and can be rendered.

In a preferred embodiment of the present invention, which supports JAVA and Eclipse, if a source code file defining a GUI component is opened, the IDE immediately renders the GUI component. Further, if any modifications are made to the GUI component's source code, the IDE immediately re-renders the GUI component to reflect the change. For example, in FIG. 1, since text editor window 102 is open for editing “foo.java,” which defines a dialog box (here constructed as a descendant of java.awt.Frame), the IDE has rendered the dialog box on the screen (as dialog box 104 in FIG. 1). If the programmer makes any modifications to the source code using text editor window 102, the IDE will re-render dialog box 104 to reflect the modifications. Since the IDE itself is GUI-based, this modification can be detected using an event handler routine (which is a routine that is called each time an event, such as a keypress or mouse-click, occurs).

In this preferred embodiment, since the IDE itself is composed of JAVA GUI code and runs in a JAVA virtual machine, the same virtual machine is used for immediate rendering of GUI components during editing. When a modification to the GUI component's source code occurs and the modified source code can be compiled into JAVA bytecode, the JAVA bytecode for the modified component is dynamically loaded into the IDE's virtual machine and executed as part of the IDE in order to render the component. This happens completely automatically as the source code is edited, so that a change in the source code causes an immediate update of the rendered GUI component, thus obviating the need to iteratively (and manually) re-compile and test the program as a whole.

Although a preferred embodiment of the invention is based on JAVA and Eclipse object-oriented GUI technology, one skilled in the art will recognize that the teachings of the present invention may be applied to other programming languages and environments, including those that are non-object-oriented. For example, many other programming languages and environments support dynamic loading of compiled program code into a currently-executing process and may thus be used to perform immediate rendering of source-code-defined GUI components. In particular, any commonly interpreted languages, especially those that are also considered to be functional languages (e.g., Lisp, Scheme), support some form of execution of dynamically loaded or program-manipulated code (e.g., through an “eval” function, as in Perl, or an “apply” function, as in Lisp) and could also be used to implement the teachings of the present invention.

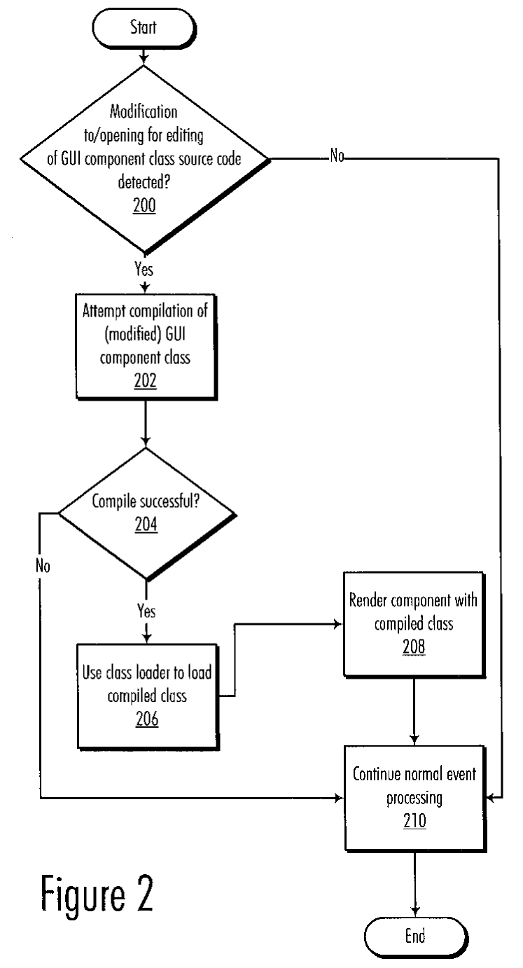

FIG. 2 is a flowchart representation of an event handler in an IDE made in accordance with a preferred embodiment of the present invention. The event handler described in FIG. 2 executes in response to a graphical user interface event (e.g., keypress, mouse click, etc.) occurring in the IDE's graphical user interface. This event handler allows for immediate rendering of a GUI component being edited in source code form in the IDE.

First, it is determined whether the event will result in the opening of a GUI component's source code for editing or the modification of a GUI component's source code (block 200). If not (block 200:No), then further event processing is performed to determine the appropriate action to take in response to the event (possibly through delegating responsibility to a subordinate event handler, as is commonly done in JAVA and other similar environments supporting event-driven programming) (block 210).

If a GUI component's source code is being opened for editing or modified (block 200:Yes), compilation of the newly opened or modified GUI component class is attempted (block 202). This compilation may or may not be successful, particularly if the source code is in the process of being modified and the modification is not complete (and hence not syntactically valid). If the compilation is not successful (block 204:No), then further event processing is performed to determine any other appropriate action(s) to take in response to the event (block 210).

If the compilation is successful (block 204:Yes), then the compiled class is dynamically loaded (using the JAVA virtual machine's class loader, in a preferred embodiment) for execution as part of the IDE (block 206). This dynamically-loaded GUI component class is then instantiated and rendered in the IDE's GUI (block 208). Finally, further event processing is performed to determine any other appropriate action(s) to take in response to the event before the event handler terminates (block 210).

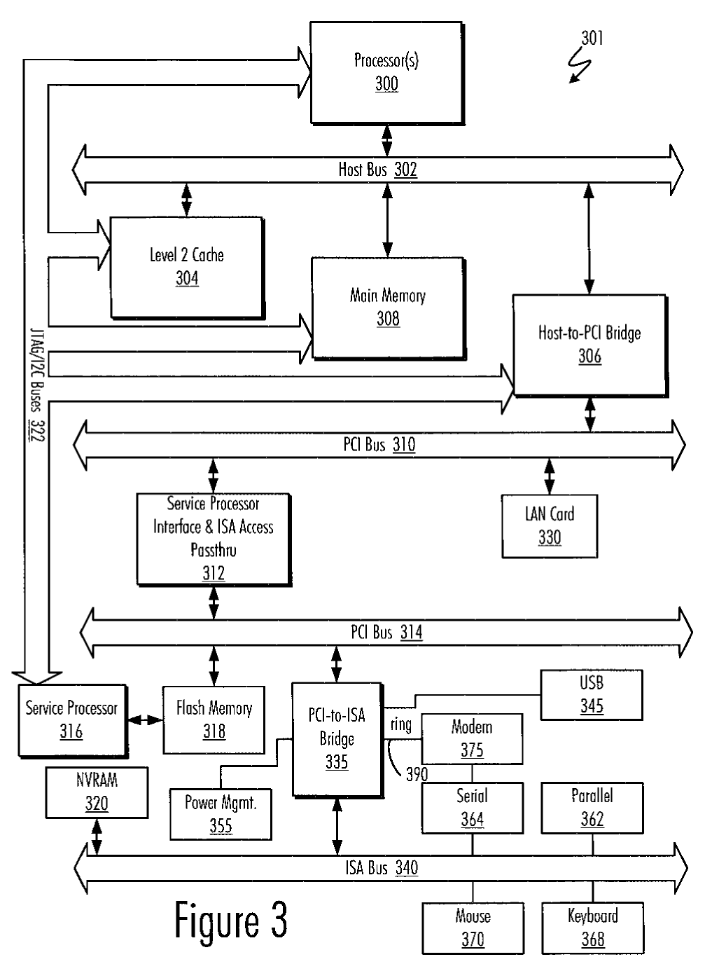

FIG. 3 illustrates information handling system 301 which is a simplified example of a computer system/data processing system capable of performing the computing operations described herein with respect to a preferred embodiment of the present invention. Computer system 301 includes processor 300 which is coupled to host bus 302. A level two (L2) cache memory 304 is also coupled to host bus 302. Host-to-PCI bridge 306 is coupled to main memory 308, includes cache memory and main memory control functions, and provides bus control to handle transfers among PCI bus 310, processor 300, L2 cache 304, main memory 308, and host bus 302. Main memory 308 is coupled to Host-to-PCI bridge 306 as well as host bus 302. Devices used solely by host processor(s) 300, such as LAN card 330, are coupled to PCI bus 310. Service Processor Interface and ISA Access Pass-through 312 provides an interface between PCI bus 310 and PCI bus 314. In this manner, PCI bus 314 is insulated from PCI bus 310. Devices, such as flash memory 318, are coupled to PCI bus 314. In one implementation, flash memory 318 includes BIOS code that incorporates the necessary processor executable code for a variety of low-level system functions and system boot functions.

PCI bus 314 provides an interface for a variety of devices that are shared by host processor(s) 300 and Service Processor 316 including, for example, flash memory 318. PCI-to-ISA bridge 335 provides bus control to handle transfers between PCI bus 314 and ISA bus 340, universal serial bus (USB) functionality 345, power management functionality 355, and can include other functional elements not shown, such as a real-time clock (RTC), DMA control, interrupt support, and system management bus support. Nonvolatile RAM 320 is attached to ISA Bus 340. Service Processor 316 includes JTAG and I2C buses 322 for communication with processor(s) 300 during initialization steps. JTAG/I2C buses 322 are also coupled to L2 cache 304, Host-to-PCI bridge 306, and main memory 308 providing a communications path between the processor, the Service Processor, the L2 cache, the Host-to-PCI bridge, and the main memory. Service Processor 316 also has access to system power resources for powering down information handling device 301.

Peripheral devices and input/output (I/O) devices can be attached to various interfaces (e.g., parallel interface 362, serial interface 364, keyboard interface 368, and mouse interface 370 coupled to ISA bus 340. Alternatively, many I/O devices can be accommodated by a super I/O controller (not shown) attached to ISA bus 340.

In order to attach computer system 301 to another computer system to copy files over a network, LAN card 330 is coupled to PCI bus 310. Similarly, to connect computer system 301 to an ISP to connect to the Internet using a telephone line connection, modem 375 is connected to serial port 364 and PCI-to-ISA Bridge 335.

While the computer system described in FIG. 3 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles. Where the word “or” is used in the claims, it is used in an inclusive sense (i.e., “A and/or B,” as opposed to “either A or B”).

What is claimed is:

1. A computer-implemented method comprising:
detecting, in a computer, a modification to a selected portion of source code in a programming language, wherein the selected portion of source code corresponds to at least one component in a graphical user interface; and
in response to detecting the modification, rendering, in the computer, the at least one component for user inspection.

2. The method of claim 1, wherein the rendering includes:
attempting to compile the selected portion of source code to obtain object code;
in response to successful compilation of the selected portion of source code, dynamically loading the object code; and
in response to dynamically loading the object code, executing at least a portion of the object code to cause the at least one component to be rendered.

3. The method of claim 2, wherein the at least a portion of the object code includes bytecode and the bytecode is executed in a virtual machine.

4. The method of claim 1, wherein the programming language is an object-oriented programming language and the selected portion of source code includes source code for a graphical user interface component class in the object oriented programming language.

5. The method of claim 4, wherein the graphical user interface component class is a descendant of a toolkit class in a graphical user interface toolkit.

6. The method of claim 5, wherein the toolkit class is a graphical user interface container class.

7. The method of claim 1, wherein the modification is detected by an event handler for an integrated development environment.

8. A computer program product in a computer-readable medium comprising functional descriptive material that, when executed by a computer, causes the computer to perform actions of:
detecting a modification to a selected portion of source code in a programming language, wherein the selected portion of source code corresponds to at least one component in a graphical user interface; and
in response to detecting the modification, rendering the at least one component for user inspection.

9. The computer program product of claim 8, wherein the rendering includes:
attempting to compile the selected portion of source code to obtain object code;
in response to successful compilation of the selected portion of source code, dynamically loading the object code; and
in response to dynamically loading the object code, executing at least a portion of the object code to cause the at least one component to be rendered.

10. The computer program product of claim 9, wherein the at least a portion of the object code includes bytecode and the bytecode is executed in a virtual machine.

11. The computer program product of claim 8, wherein the programming language is an object-oriented programming language and the selected portion of source code includes source code for a graphical user interface component class in the object oriented programming language.

12. The computer program product of claim 11, wherein the graphical user interface component class is a descendant of a toolkit class in a graphical user interface toolkit.

13. The computer program product of claim 12, wherein the toolkit class is a graphical user interface container class.

14. The computer program product of claim 8, wherein the modification is detected by an event handler for an integrated development environment.

15. A data processing system comprising:
at least one processor;
storage accessible to the at least one processor; and
a set of instructions in the storage, wherein the at least one processor executes the set of instructions to perform actions of:
detecting a modification to a selected portion of source code in a programming language, wherein the selected portion of source code corresponds to at least one component in a graphical user interface; and
in response to detecting the modification, rendering the at least one component for user inspection.

16. The data processing system of claim 15, wherein the rendering includes:
attempting to compile the selected portion of source code to obtain object code;
in response to successful compilation of the selected portion of source code, dynamically loading the object code; and
in response to dynamically loading the object code, executing at least a portion of the object code to cause the at least one component to be rendered.

17. The data processing system of claim 16, wherein the at least a portion of the object code includes bytecode and the bytecode is executed in a virtual machine.

18. The data processing system of claim 15, wherein the programming language is an object-oriented programming language and the selected portion of source code includes source code for a graphical user interface component class in the object oriented programming language.

19. The data processing system of claim 18, wherein the graphical user interface component class is a descendant of a toolkit class in a graphical user interface toolkit.

20. The data processing system of claim 15, wherein the modification is detected by an event handler for an integrated development environment.
